(19) United States
(12) Patent Application Publication
(10) Pub. No.: US 2020/0346702 A1
(43) Pub. Date: Nov. 5, 2020

(54) ADJUSTABLE BIKE RACK WITH COVER

(71) Applicant: Eric Mobley, Arlington, TX (US)

(72) Inventor: Eric Mobley, Arlington, TX (US)

(21) Appl. No.: 16/862,217

(22) Filed: Apr. 29, 2020

Related U.S. Application Data
(60) Provisional application No. 62/841,037, filed on Apr. 30, 2019.

(51) Int. Cl. B62H 3/12; B62J 19/00

(52) U.S. Cl. CPC B62H 3/12; B62H 2700/00; B62J 19/00

(57) ABSTRACT

An adjustable bike rack assembly includes a frame having a plurality of support poles and a beam. The beam extends between a portion of the support poles. A fastener is coupled to the beam to support a bike at least partially suspended in the air. A cover is also included and is coupled to the frame and configured to extend along the poles from the beam down to the ground. The height of the beam or frame may be adjusted by adjusting the length of the poles.

### CROSS REFERENCE TO RELATED APPLICATIONS

This application claims the benefit of earlier filing date and right of priority to U.S. Provisional Application No. 62/841,037, filed 30 Apr. 2019, the contents of which is incorporated by reference herein in its entirety.

### BACKGROUND OF THE INVENTION

### 1. Field of the Invention

The present application relates to a storage rack, and more particularly to a bike rack storage system.

### 2. Description of Related Art

Various methods of storing bikes have become common practice. Often, a bike is simply left to lean against a wall in a garage or shed. However, this method takes up valuable storage space in the storage area. A second method used in the storage of bikes is to hang them from a ceiling. This practice causes the bikes to take up standing space in garages and walk-in sheds and makes it hard to work around them. Lastly, bikes are stored outside. When outside, bikes are more prone to theft and environmental problems, such as sun and water damage. Thus, it is seen that none of these common practices are as effective as they are led to believe.

Although great strides have been made with respect to the storage methods of bikes, considerable shortcomings remain.

### BRIEF SUMMARY OF THE INVENTION

It is an object of the present application to provide a bike storage system for the outdoor storage of bikes away from the weather and sun. The system and method of the present application includes a support structure, consisting of a plurality of support poles joined at a junction. The junction is used to couple the poles to a beam. Attached to a surface of the beam are a series of fasteners, arrayed at intervals with the intention of supporting one or more bikes off the ground. A cover is draped over the top and secured at the support poles. This cover can be rolled up and secured at the top of the structure next to the beam, to allow easier access to the hanging bikes. Additionally, it may be stored remote from the structure or at any other location on the structure depending on design and application constraints.

Ultimately the invention may take many embodiments. In these ways, the present invention overcomes the disadvantages inherent in the prior art. The more important features have thus been outlined in order that the more detailed description that follows may be better understood and to ensure that the present contribution to the art is appreciated. Additional features will be described hereinafter and will form the subject matter of the claims that follow.

Many objects of the present application will appear from the following description and appended claims, reference being made to the accompanying drawings forming a part of this specification wherein like reference characters designate corresponding parts in the several views.

Before explaining at least one embodiment of the present invention in detail, it is to be understood that the embodiments are not limited in its application to the details of construction and the arrangements of the components set forth in the following description or illustrated in the drawings. The embodiments are capable of being practiced and carried out in various ways. Also it is to be understood that the phraseology and terminology employed herein are for the purpose of description and should not be regarded as limiting.

As such, those skilled in the art will appreciate that the conception, upon which this disclosure is based, may readily be utilized as a basis for the designing of other structures, methods and systems for carrying out the various purposes of the present design. It is important, therefore, that the claims be regarded as including such equivalent constructions insofar as they do not depart from the spirit and scope of the present application.

### BRIEF DESCRIPTION OF THE DRAWINGS

The novel features believed characteristic of the application are set forth in the appended claims. However, the application itself, as well as a preferred mode of use, and further objectives and advantages thereof, will best be understood by reference to the following detailed description when read in conjunction with the accompanying drawings, wherein:

FIG. 1 is front view of a hanging storage system for bikes according to an embodiment of the present application.

FIG. 2 is a side view of the hanging storage system of FIG. 1.

While the embodiments and method of the present application is susceptible to various modifications and alternative forms, specific embodiments thereof have been shown by way of example in the drawings and are herein described in detail. It should be understood, however, that the description herein of specific embodiments is not intended to limit the application to the particular embodiment disclosed, but on the contrary, the intention is to cover all modifications, equivalents, and alternatives falling within the spirit and scope of the process of the present application as defined by the appended claims.

### DETAILED DESCRIPTION OF THE INVENTION

Illustrative embodiments of the preferred embodiment are described below. In the interest of clarity, not all features of an actual implementation are described in this specification. It will of course be appreciated that in the development of any such actual embodiment, numerous implementation-specific decisions must be made to achieve the developer's specific goals, such as compliance with system-related and business-related constraints, which will vary from one implementation to another. Moreover, it will be appreciated that such a development effort might be complex and time-consuming but would nevertheless be a routine undertaking for those of ordinary skill in the art having the benefit of this disclosure.

In the specification, reference may be made to the spatial relationships between various components and to the spatial orientation of various aspects of components as the devices are depicted in the attached drawings. However, as will be recognized by those skilled in the art after a complete reading of the present application, the devices, members, apparatuses, etc. described herein may be positioned in any desired orientation. Thus, the use of terms to describe a spatial relationship between various components or to describe the spatial orientation of aspects of such components should be understood to describe a relative relationship between the components or a spatial orientation of aspects of such components, respectively, as the embodiments described herein may be oriented in any desired direction.

The embodiments and method in accordance with the present application overcomes one or more of the above-discussed problems commonly associated with the prior art discussed previously. Specifically, the new system overcomes the struggles of awkward storage with bikes by allowing for an ease of access to and around the bikes. This method is further specialized by the built-in protection to sun and water, as well as keeping the bikes out of sight of would be thieves. These and other unique features are discussed below and illustrated in the accompanying drawings.

The embodiments and method will be understood, both as to its structure and operation, from the accompanying drawings, taken in conjunction with the accompanying description. Several embodiments of the assembly may be presented herein. It should be understood that various components, parts, and features of the different embodiments may be combined together and/or interchanged with one another, all of which are within the scope of the present application, even though not all variations and particular embodiments are shown in the drawings. It should also be understood that the mixing and matching of features, elements, and/or functions between various embodiments is expressly contemplated herein so that one of ordinary skill in the art would appreciate from this disclosure that the features, elements, and/or functions of one embodiment may be incorporated into another embodiment as appropriate, unless otherwise described.

Referring now to the Figures wherein like reference characters identify corresponding or similar elements in form and function throughout the several views. The following Figures describe embodiments of the present application and its associated features. With reference now to the Figures, embodiments of the present application are herein described. It should be noted that the articles “a”, “an”, and “the”, as used in this specification, include plural referents unless the content clearly dictates otherwise.

The system and method of the present application is a bike rack with a cover. The bike rack includes a frame defining support structure, consisting of support poles joined at a junction. The junction is used to couple the poles to a beam. Attached to a lower surface of the beam are a series of hooks, spaced at regular intervals with the intention of supporting multiple bikes off the ground. All methods of how the bikes in question are hung remains to the choice of the consumer. A built-in cover is draped over the top and secured at the A-frame support system. This cover can be rolled up and secured at the top of the structure next to the beam, to allow easier access to the hanging bikes. Additionally it may be stored remote from the structure or at any other location on the structure depending on design and application constraints.

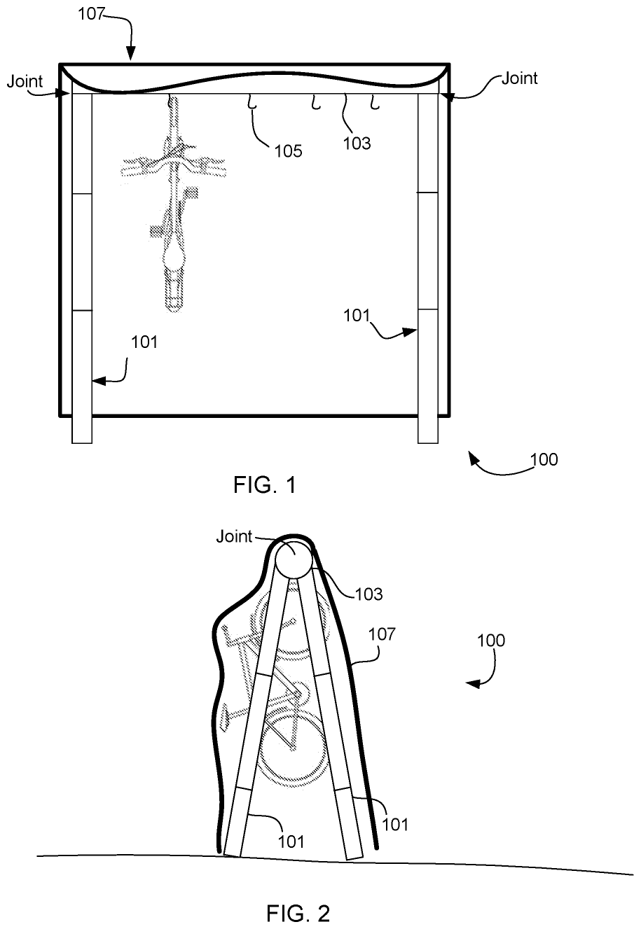

Referring now to FIGS. 1 and 2 in the drawings, a bike storage system 100 is illustrated. System 100 includes a structure or frame and a cover 107. The frame has a plurality of legs/support poles 101, a beam 103, and a line of fasteners 105. A plurality of legs are attached at a joint on either side of a beam. The beam is supported in the air by the legs, which remain on the ground.

Secured to the underside of the beam is a series of fasteners 105. These are spaced apart along its length as defined intervals. The intervals can be equal across the entire length or varied. An example of fasteners 105 are a hook. Fasteners 105 are designed for (but not limited to) the raising and storing of a series of bikes off the ground. It is understood that fasteners 105 may be any type of fastener and operable in different ways. Fasteners 105 couple to beam 103 and are configured to support the weight of a bike of the ground.

Support poles 101 are typically rigid allowing for the force or weight of beam 103 and any bikes to be distributed equally. The poles may be telescoping to permit an adjustment of length and therefore an overall height adjustment of the frame. Poles 101 may also be formed from a plurality of sections having ends that couple together. The support poles may be configured to adjust in length. This can be done in many ways, for example, support poles 101 may telescope along its length. Additionally, if multiple sections are used to form poles 101, then one or more sections may be removed.

The cover 107 for the storage system can be removed or secured to the various poles 107 and/or beam 103 for the convenience of the consumer. When attached, the cover 107 may be opened up on one side of the system, allowing for easier access to the interior of the frame and any bikes.

Referring now to FIG. 2 in the drawings, a side view of the bike storage system of FIG. 1 is illustrated. The cover 107 of the storage system 100 may be attached along the sides of the poles 101 that support the beam 103. Additionally, it may be anchored to the ground by any means desired. The poles 101 contact the ground and work together to support beam 103 above the ground, with adequate space for the stored goods beneath, such as a bike.

It is important to note that the specific design of the poles that make up the poles 101 and the beam 103 does not depend on a particular material. Any configuration may be used and is not limited to that depicted in the Figures. The cover also can be any type of material or shape and may allow varying degrees of porosity. Cover 107 may extend on one or both sides of the frame.

The particular embodiments disclosed above are illustrative only, as the application may be modified and practiced in different but equivalent manners apparent to those skilled in the art having the benefit of the teachings herein. It is therefore evident that the particular embodiments disclosed above may be altered or modified, and all such variations are considered within the scope and spirit of the application. Accordingly, the protection sought herein is as set forth in the description. It is apparent that an application with significant advantages has been described and illustrated. Although the present application is shown in a limited number of forms, it is not limited to just these forms, but is amenable to various changes and modifications without departing from the spirit thereof.

What is claimed is:

1. An adjustable rack assembly, comprising:
a frame having a plurality of support poles and a beam, the beam extending between a portion of the support poles;
a fastener coupled to the beam; and
a cover coupled to the frame and configured to extend along the poles.

2. The assembly of claim 1, wherein the poles are adjustable in length.

3. The assembly of claim 2, wherein the poles include a plurality of sections selectively removable from one another.

4. The assembly of claim 2, wherein the poles are configured to telescope relative to one another.

5. The assembly of claim 1, wherein the poles are oriented so as to form an A-frame configuration.

6. The assembly of claim 1, wherein the cover extends from the beam to a distal end of the poles.

7. The assembly of claim 1, wherein the cover is detachable.

8. The assembly of claim 1, wherein the cover extends down a single side of the frame.
